(19) United States
(12) Patent Application Publication
(10) Pub. No.: US 2007/0007887 A1
(43) Pub. Date: Jan. 11, 2007

(54) Plasma display panel (PDP)

(76) Inventors: Hyun Soh, Suwon-si (KR); Kyoung-Doo Kang, Suwon-si (KR); Se-Jong Kim, Suwon-si (KR); Yun-Hee Kim, Suwon-si (KR); Hyun Kim, Suwon-si (KR); Jin-Won Han, Suwon-si (KR)

Correspondence Address: Robert E. Bushnell, Suite 300, 1522 K Street, N.W., Washington, DC, 20005-1202, US

(21) Appl. No.: 11/476,551

(22) Filed: Jun. 29, 2006

(30) Foreign Application Priority Data
Jul. 7, 2005 (KR) 10-2005-0061163

(51) Int. Cl. H01J 1/62

(52) U.S. Cl. 313/505

(57) ABSTRACT

A Plasma Display Panel (PDP) includes a first panel and a second panel, the first panel facing the second panel and having a plurality of discharge cells arranged between the first panel and the second panel. The first panel includes a first substrate, X and Y electrodes extending on the first substrate, and a first dielectric layer adapted to cover the X and Y electrodes and having groove shaped field concentration units arranged on a surface thereof facing the discharge cells. An inner surface of each field concentration unit is concave with respect to a central portion thereof.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on the 7^{th} of Jul. 2005 and there duly assigned Serial No. 10-2005-0061163.

### BACKGROUND OF THE INVENTION

1. Field of the Invention

The present invention relates to a Plasma Display Panel (PDP), and more particularly, to a PDP having a groove shaped field concentration unit between electrodes that generate a discharge.

2. Description of the Related Art

Recently, the use of Plasma Display Panels (PDPs) as large flat display devices has been emphasized. A PDP includes two substrates with a space filled with a discharge gas therebetween, and a plurality of electrodes formed on the substrates. The PDP displays desired images using visible light emitted though a process of exciting a phosphor material in a predetermined pattern with ultraviolet light rays generated by a discharge of the discharge gas in the space when a voltage is supplied to the electrodes.

A PDP includes a first panel and a second panel. The first panel includes a first substrate, X and Y electrodes (common and scanning electrodes), each including a transparent electrode and a bus electrode; a first dielectric layer; and a protection film. The second panel includes a second substrate, A electrodes (address electrodes), a second dielectric layer, barrier ribs, and a phosphor layer.

The first substrate and the second substrate are parallel to each other, and separated from each other such that they face each other. A space formed between the two substrates is partitioned by the barrier ribs into unit discharge cells in which discharge occurs. The X and Y electrodes intersect with A electrodes in each discharge cell. A panel capacitor is formed in each of the discharge cells by the dielectric layer and the electrodes included in the discharge cell.

When the distance between the X and Y electrodes is reduced, a driving voltage supplied to the electrodes can be reduced proportionally to the distance reduction. However, in this case, the light emission efficiency of the PDP is reduced since a wide discharge space cannot be utilized, making it difficult to display bright images. Also, when the distance between the X and Y electrodes is reduced, the panel capacitance increases proportionally to the distance reduction.

When the distance between the X and Y electrodes, which generate a sustain discharge, is increased, a wide discharge space can be utilized, thereby increasing light emission efficiency. However, a driving voltage must be increased in proportion to the increase in distance, resulting in increased power consumption.

### SUMMARY OF THE INVENTION

The present invention provides a Plasma Display Panel (PDP) with a minimal reduction in the transmittance of visible light emitted from a discharge cell due to the inclusion of a field concentration unit having a concave inner surface.

According to one aspect of the present invention, a Plasma Display Panel (PDP) is provided including: a first panel and a second panel, the first panel facing the second panel and having a plurality of discharge cells arranged between the first panel and the second panel, the first panel including: a first substrate; X and Y electrodes extending on the first substrate; and a first dielectric layer adapted to cover the X and Y electrodes and having groove shaped field concentration units arranged on a surface thereof facing the discharge cells, an inner surface of each field concentration unit being concave with respect to a central portion thereof.

A middle portion of each field concentration unit is preferably a widest portion thereof upon a vertical cross-section thereof being viewed such that the first panel is located above the second panel. A horizontal width of an upper portion of each field concentration unit is preferably equal to a horizontal width of a lower portion. An upper portion of each field concentration unit preferably contacts the first substrate. A lower portion of each field concentration unit is preferably a widest portion thereof upon a vertical cross-section thereof being viewed such that the first panel is located above the second panel. An upper portion of each field concentration unit is preferably a narrowest portion thereof. The upper portion of the each concentration unit preferably contacts the first substrate.

A transmission of visible light emitted from each discharge cell through the first panel preferably depends on a width of a vertical portion of an inner surface of each field concentration unit.

Each field concentration unit is preferably parallel to a direction in which the X and Y electrodes extend and is arranged between the X and Y electrodes. Each field concentration unit is preferably symmetrical upon a vertical cross-section thereof being viewed such that the first panel is located above the second panel. A horizontal cross-section of each field concentration unit is preferably a polygonal shape selected from the group consisting of a rectangular shape, a hexagonal shape and an octagonal shape, a circular shape, or an oval shape.

According to another aspect of the present invention, a Plasma Display Panel (PDP) is provided including: a first substrate; a second substrate separated from and facing the first substrate; barrier ribs adapted to define a plurality of discharge cells in a space between the first substrate and the second substrate; X electrodes and Y electrodes extending on the first substrate; a first dielectric layer adapted to cover the X and Y electrodes and having groove shaped field concentration units arranged on a surface thereof facing the plurality of discharge cells, an inner surface of each field concentration unit being concave with respect to a central portion thereof; A electrodes arranged on the second substrate and extending to intersect the X electrodes and the Y electrodes; a second dielectric layer adapted to cover the A electrodes; a phosphor layer arranged in the plurality of discharge cells; and a discharge gas contained within a discharge space of the plurality of discharge cells.

A middle portion of each field concentration unit is preferably a widest portion thereof upon a vertical cross-section thereof being viewed such that the first substrate is located above the second substrate. An upper portion of each field concentration unit preferably contacts the first substrate. A lower portion of each field concentration unit is preferably a widest portion thereof upon a vertical cross-section thereof being viewed such that the first substrate is located above the second substrate. An upper portion of each field concentration unit preferably contacts the first substrate.

Transmission of visible light emitted from each discharge cell through the first substrate preferably depends on a width of a vertical portion of an inner surface of each field concentration unit.

The PDP preferably further includes a protection film adapted to protect the first dielectric layer.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial perspective view of a Plasma Display Panel (PDP) having a field concentration unit according to an embodiment of the present invention;

FIG. 2 is a cross-sectional view taken along line II-II of FIG. 1;

FIG. 3 is a schematic drawing of a field concentration unit as seen from a first substrate of the PDP of FIG. 1; and

FIG. 4 is a cross-sectional view of a discharge cell of a PDP according to another embodiment of the present invention.

### DETAILED DESCRIPTION OF THE INVENTION

The present invention is described more fully below with reference to the accompanying drawings in which exemplary embodiments of the present invention are shown.

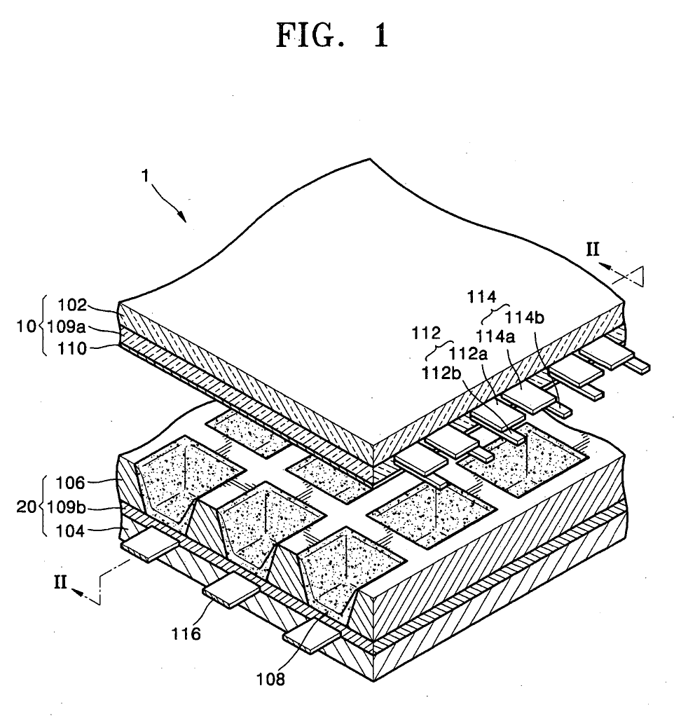

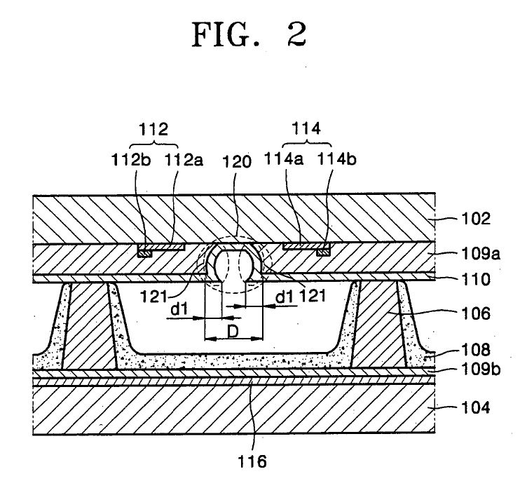

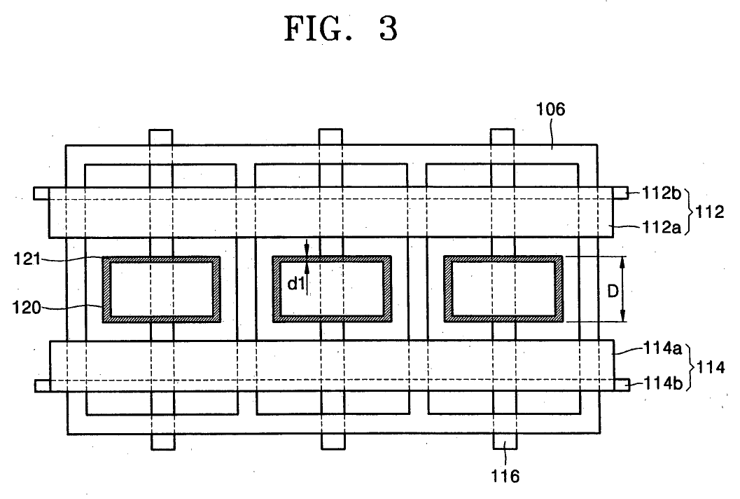

FIG. 1 is a partial perspective view of a PDP 1 having a field concentration unit according to an embodiment of the present invention. FIG. 2 is a cross-sectional view taken along line II-II of FIG. 1. FIG. 3 is a schematic drawing of a field concentration unit as seen from a first substrate 102 of the Plasma Display Panel (PDP) of FIG. 1.

Referring to FIGS. 1 through 3, the PDP 1 includes a first panel 10 and a second panel 20. The first panel 10 includes the first substrate 102, X electrodes 112, Y electrodes 114, a first dielectric layer 109a, and a protection film 110. Each of the X electrodes 112 includes a transparent electrode 112a and a bus electrode 112b. Each of the Y electrodes 114 includes a transparent electrode 114a and a bus electrode 114b. The second panel 20 includes a second substrate 104, A electrodes 116, a second dielectric layer 109b, barrier ribs 106, and a phosphor layer 108.

The first substrate 102 and the second substrate 104 are spaced a predetermined distance apart and face each other. The first substrate 102 can be parallel to the second substrate 104. The barrier ribs 106 define a plurality of discharge cells in the space between the first substrate 102 and the second substrate 104. The X electrodes 112 and the Y electrodes 114 extend parallel to each other on the first substrate 102.

The A electrodes 116 are located on the second substrate 104 and are perpendicular to the X electrodes 112 and the Y electrodes 114. The X electrodes 112 and the Y electrodes 114 can intersect the A electrodes 116 in each discharge cell. The phosphor layer 108 is formed on the barrier ribs 106 and the second dielectric layer 109b. A discharge gas is contained within the discharge cells.

The first dielectric layer 109a covers the X electrodes 112 and the Y electrodes 114. Groove shaped field concentration units 120 are formed on a surface of the first dielectric layer 109a facing the discharge cells. The inner surface 121 of the field concentration unit 120 can be concave with respect to the central part of the field concentration unit 120.

To protect the first dielectric layer 109a, the protection film 110, which can be formed of magnesium oxide (MgO), is located on a surface of the first dielectric layer 109a adjacent to the discharge cell. The second dielectric layer 109b covers the A electrodes 116.

The barrier ribs 106 define unit discharge cells where a discharge takes place in the space between the first substrate 102 and the second substrate 104. A discharge gas at a pressure lower than atmospheric pressure (approximately less than 0.5 atm) is contained within the discharge cells. A plasma discharge is generated by the collision of particles of the discharge gas with charges due to an electric field formed by a driving voltage supplied to the electrodes located in each discharge cell, and, as a result of the plasma discharge, vacuum ultraviolet rays are generated.

The discharge gas can be a gas mixture containing one or more of Ne gas, He gas, and Ar gas mixed with Xe gas.

The barrier ribs 106 define the discharge cells to be basic units of an image, and prevent cross-talk between the discharge cells. According to an embodiment of the present invention, a horizontal cross-section of the discharge cells, i.e., a cross-section parallel to the first substrate 102 and the second substrate 104, can be polygonal, for example, rectangular, hexagonal, or octagonal; circular; or oval, and can vary according to the arrangement of the barrier ribs 106.

Electrons in the phosphor layer 108 are excited by absorbing vacuum ultraviolet rays generated by the discharge, and photo luminescence occurs. That is, visible light is generated when the excited electrons of the phosphor layer 108 return to a stable state. The phosphor layer 108 can include red, green, blue phosphor layers such that the PDP can display a color image. The red, green, and blue phosphor layers can constitute a unit pixel in the discharge cell.

The red phosphor can be (Y,Gd)BO₃:Eu³⁺, etc., the green phosphor can be Zn₂Si0₄:Mn²⁺, etc., and the blue phosphor can be BaMgAl₁₀O₁₇:Eu²⁺, etc. In the drawings, the phosphor layer 108 is formed on the second dielectric layer 109b and the barrier ribs 106 of the discharge cell. However, the locations of the phosphor layer according to embodiments of the present invention are not limited thereto, and various arrangements can be used.

The first dielectric layer 109a is used as an insulating film for insulating the X electrodes 112 and the Y electrodes 114, and is formed of a material having high electrical resistance and high light transmittance. Some of the charges generated by the discharge form wall charges on the protection film 110 near the first dielectric layer 109a by being attracted to an electrical attractive force caused by the polarity of a voltage supplied to each of the X and Y electrodes 112 and 114.

The second dielectric layer 109b is used as an insulating film for insulating the A electrodes 116, and is formed of a material having a high electrical resistance.

The protection film 110 protects the first dielectric layer 109a, and facilitates the discharge by increasing the emission of secondary electrons. The protection film 110 is formed of a material such as magnesium oxide (MgO), etc.

The transparent electrodes 112a and 114a are formed of a transparent material such as Indium Tin Oxide (ITO) to transmit visible light emitted from the discharge cells. The transparent electrodes 112a and 114a can have a high electrical resistance. The electrical conductivity of the transparent electrodes 112a and 114a is increased by the inclusion of the bus electrodes 112b and 114b formed of a metal having high electrical conductivity.

However, the present invention is not limited to the above mentioned structure in which the X electrodes 112 and the Y electrodes 114 each include a bus electrode and a transparent electrode, but can also be applied to a PDP in which the X electrodes 112 and the Y electrodes 114 each include the bus electrode without the transparent electrode, that is, in a structure without any ITO.

The field concentration unit 120 is formed, for example, by etching the first dielectric layer 109a. A discharge path between the X electrodes 112 and the Y electrodes 114 is reduced by the field concentration unit 120. The field concentration effects of the central portion of the groove shaped space of the field concentration unit 120 together with the reduced discharge path increase the density of electrons (negative charges) and ions (positive charges) in the field concentration unit 120, thereby facilitating the occurrence of a discharge between the X electrodes 112 and the Y electrodes 114. Also, the discharge space can be increased by increasing the distance between the X electrodes 112 and the Y electrodes 114, thus increasing the light emission efficiency. Also, the transmittance of visible light emitted from the discharge cell through the first panel 10 can be increased in proportion to the amount of the first dielectric layer 109a that is etched.

Visible light emitted from the discharge cell cannot penetrate the first panel 10 due to diffused reflection or scattering of the visible light at the inner surface 121 of the field concentration unit 120. Therefore, when the image is seen by a user, the inner surface 121 of the field concentration unit 120 appears as a black spot.

The wider the area of the black spot, the lower the transmittance of the visible light through the first panel 10. The area of the black spot is determined by the width d1 of the horizontal portion of the inner surface 121 of the field concentration unit 120. That is, the transmittance of the visible light emitted from the discharge cell is severely reduced as the width d1 the vertical portion of the inner surface 121 of the field concentration unit 120 is increased.

In an embodiment of the present invention, the inner surface 121 of the field concentration unit 120 is concave to reduce the width d1 of the vertical portion of the inner surface 121 of the field concentration unit 120. The transmittance of visible light can be increased proportionally to the reduction in the width d1 of the vertical portion of the inner surface 121 of the field concentration unit 120.

The inner surface 121 of the field concentration unit 120 can be inclined at a predetermined angle. However, in this case, the inner surface 121 of the field concentration unit 120 can cause a diffused reflection or scattering of visible light emitted from the discharge cell, and the inclined inner surface 121 of the field concentration unit 120 can be a hindrance to the transmission of visible light through the first panel 10. That is, the inner surface 121 of the field concentration unit 120 can reduce the transmittance of the visible light emitted from the discharge cell through the first panel 10 when the inner surface 121 of the field concentration unit 120 is inclined.

Also, to remove the black spot, the inner surface 121 of the field concentration unit 120 can be perpendicular to the first substrate 102. However, in this case, the practical manufacturing process for forming the field concentration unit 120 is very difficult. That is, the formation of a rectangular shaped groove in the first dielectric layer 109a is very difficult since the first dielectric layer 109a is very thin and the vertical portion of the inner surface 121 of the field concentration unit 120 is very thin.

According to another embodiment of the present invention, the horizontal cross-section of the field concentration unit 120, i.e., a cross-section parallel to the first substrate 102, can be polygonal, for example, rectangular, circular or oval.

In an embodiment of the present invention, the inner surface 121 of the field concentration unit 120 is concave with respect to the central portion of the field concentration unit 120. Accordingly, the vertical portion of the inner surface 121 of the field concentration unit 120 is narrow, and the reduction in the transmittance of visible light emitted from the discharge cell through the first panel 10 can be reduced.

The black spot has a negative effect on the transmittance of visible light emitted from the discharge cell through the first panel 10, but, at the same time, has a positive effect in that the black spot increases contrast (color contrast ratio or light contrast ratio) of the panel by reducing the reflectance of external visible light entering the first panel from the outside. However, when the locations and area of the black spot are produced incorrectly, the quality of an image displayed on the PDP is greatly degraded. Therefore, the black spot must be created with utmost care. According to embodiments of the present invention, the PDP includes the black spots while minimizing the reduction in the transmittance of visible light emitted from the discharge cell.

Referring to FIG. 2, when the vertical cross-section of the field concentration unit 120, i.e., a cross-section perpendicular to the direction in which the X electrodes 112 and the Y electrodes 114 extend, is viewed such that the first panel 10 is located above the second panel 20, the horizontal width D of the middle portion of the field concentration unit 120 can be greater than the horizontal widths of the upper and lower portions of the field concentration unit 120. That is, the middle portion of the field concentration unit 120 is the widest portion of the field concentration unit 120. The horizontal width of the upper portion of the field concentration unit 120 can be the same as the horizontal width of the lower portion of the field concentration unit 120. Also, the upper portion of the field concentration unit 120 can contact the first substrate 102.

Also, when the vertical cross-section of the field concentration unit 120 is viewed such that the first panel 10 is located above the second panel 20, the field concentration unit 120 may be symmetrical.

One factor that determines the transmission of visible light emitted from the discharge cell through the first dielectric layer 109a is the width d1 of the vertical portion of the inner surface 121 of the field concentration unit 120. Accordingly, the transmission of the visible light emitted from the discharge cell through the first panel 10 can be controlled by the width d1 of the vertical portion of the inner surface 121 of the field concentration unit 120.

Also, as depicted in FIG. 3, the field concentration units 120 can extend parallel to the X and Y electrodes 112 and 114, between the X electrodes 112 and the Y electrodes 114.

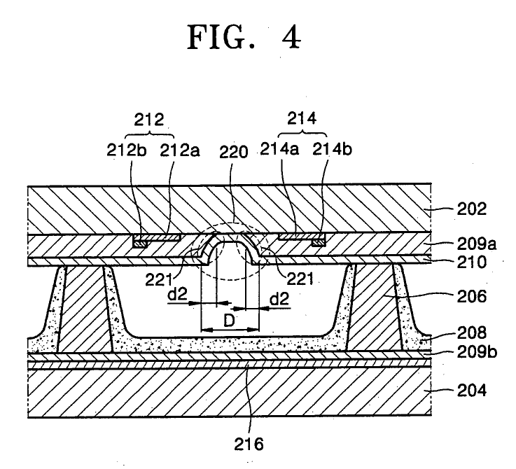

FIG. 4 is a cross-sectional view of a discharge cell of a PDP according to another embodiment of the present invention.

Referring to FIG. 4, the PDP according to the present embodiment has a field concentration unit 220 having a different shape than the field concentration unit 120 illustrated in FIG. 2. In FIGS. 2 and 4, similar reference numerals refer to like elements performing the same functions, and detailed descriptions thereof have not been repeated.

In the PDP according to the present embodiment, when the vertical cross-section of the field concentration unit 220, i.e., a cross-section perpendicular to the direction in which the X electrodes 212 and the Y electrodes 214 extend, is viewed such that the first panel 10 is located above the second panel 20, the horizontal width D at the lower portion of the field concentration unit 220 is greater than the horizontal width of the middle portion of the field concentration unit 220 and the horizontal width of the upper portion of the field concentration unit 220. That is, the lower portion of the field concentration unit 220 is the widest portion of the field concentration unit 220. Also, the upper portion of the field concentration unit 220 is the narrowest portion of the field concentration unit 220.

Also, the upper portion of the field concentration unit 220 can contact a first substrate 202. However, in another embodiment of the present invention, a first dielectric layer 209a formed of a dielectric material can be interposed between the upper portion of the field concentration unit 220 and the first substrate 202.

A factor that determines the transmission of visible light emitted from the discharge cell through the first panel 10 (see FIG. 1) can be the width d2 of the vertical portion of the inner surface 221 of the field concentration unit 220. The width d2 of the vertical portion of the inner surface 221 of the field concentration unit 220 is determined by the concavity of the inner surface 221 or the curvature of the field concentration unit 220. The concavity of the inner surface 221 or the curvature of the field concentration unit 120 can be an important factor in the transmittance of visible light emitted from the discharge cell through the first panel 10.

A PDP having a field concentration unit according to the present invention can minimize a reduction in transmittance of visible light emitted from a discharge cell since the inner surface of the field concentration unit is concave.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP) comprising:
a first panel and a second panel, the first panel facing the second panel and having a plurality of discharge cells arranged between the first panel and the second panel, the first panel including:
a first substrate;
X and Y electrodes extending on the first substrate; and
a first dielectric layer adapted to cover the X and Y electrodes and having groove shaped field concentration units arranged on a surface thereof facing the discharge cells, an inner surface of each field concentration unit being concave with respect to a central portion thereof.

2. The PDP of claim 1, wherein a middle portion of each field concentration unit is a widest portion thereof upon a vertical cross-section thereof being viewed such that the first panel is located above the second panel.

3. The PDP of claim 2, wherein a horizontal width of an upper portion of each field concentration unit is equal to a horizontal width of a lower portion.

4. The PDP of claim 2, wherein an upper portion of each field concentration unit contacts the first substrate.

5. The PDP of claim 1, wherein a lower portion of each field concentration unit is a widest portion thereof upon a vertical cross-section thereof being viewed such that the first panel is located above the second panel.

6. The PDP of claim 5, wherein an upper portion of each field concentration unit is a narrowest portion thereof.

7. The PDP of claim 6, wherein the upper portion of the each concentration unit contacts the first substrate.

8. The PDP of claim 1, wherein a transmission of visible light emitted from each discharge cell through the first panel depends on a width of a vertical portion of an inner surface of each field concentration unit.

9. The PDP of claim 1, wherein each field concentration unit is parallel to a direction in which the X and Y electrodes extend and is arranged between the X and Y electrodes.

10. The PDP of claim 1, wherein each field concentration unit is symmetrical upon a vertical cross-section thereof being viewed such that the first panel is located above the second panel.

11. The PDP of claim 1, wherein a horizontal cross-section of each field concentration unit is a polygonal shape, a circular shape, or an oval shape.

12. The PDP of claim 11, wherein the polygonal shape is one selected from the group consisting of a rectangular shape, a hexagonal shape, and an octagonal shape.

13. A Plasma Display Panel (PDP) comprising:
a first substrate;
a second substrate separated from and facing the first substrate;
barrier ribs adapted to define a plurality of discharge cells in a space between the first substrate and the second substrate;
X electrodes and Y electrodes extending on the first substrate;
a first dielectric layer adapted to cover the X and Y electrodes and having groove shaped field concentration units arranged on a surface thereof facing the plurality of discharge cells, an inner surface of each field concentration unit being concave with respect to a central portion thereof;
A electrodes arranged on the second substrate and extending to intersect the X electrodes and the Y electrodes;
a second dielectric layer adapted to cover the A electrodes;
a phosphor layer arranged in the plurality of discharge cells; and
a discharge gas contained within a discharge space of the plurality of discharge cells.

14. The PDP of claim 13, wherein a middle portion of each field concentration unit is a widest portion thereof upon a vertical cross-section thereof being viewed such that the first substrate is located above the second substrate.

15. The PDP of claim 14, wherein an upper portion of each field concentration unit contacts the first substrate.

16. The PDP of claim 13, wherein a lower portion of each field concentration unit is a widest portion thereof upon a vertical cross-section thereof being viewed such that the first substrate is located above the second substrate.

17. The PDP of claim 16, wherein an upper portion of each field concentration unit contacts the first substrate.

18. The PDP of claim 13, wherein transmission of visible light emitted from each discharge cell through the first substrate depends on a width of a vertical portion of an inner surface of each field concentration unit.

19. The PDP of claim 13, further comprising a protection film adapted to protect the first dielectric layer.
